(19) United States
(12) Patent Application Publication
(10) Pub. No.: US 2012/0162060 A1
(43) Pub. Date: Jun. 28, 2012

(54) LASER NAVIGATION MODULE

(75) Inventors: Dong Ik Shin, Gyunggi-do (KR); Bu Whan Hyun, Gyunggi-do (KR); Seung Heon Han, Gyunggi-do (KR); Ki Hoon Jang, Gyunggi-do (KR); Ho Chul Joung, Gyunggi-do (KR); Woo Seok Yang, Gyunggi-do (KR)

(73) Assignee: SAMSUNG ELECTRO-MECHANICS CO., LTD., Gyunggi-do (KR)

(21) Appl. No.: 13/042,069

(22) Filed: Mar. 7, 2011

(30) Foreign Application Priority Data
Dec. 27, 2010 (KR) 1020100135563

(51) Int. Cl. G09G 5/00

(52) U.S. Cl. 345/156

(57) ABSTRACT

Disclosed herein is a laser navigation module, including: a light source radiating a laser beam; a housing provided with a window transmitting and reflecting the laser beam radiated from the light source and shielding the introduction of visible rays and provided with a transparent part or a translucent part to radiate light radiated from the inside thereof to the outside; a lighting device mounted in the housing; and a light diffusing member transferring the light radiated from the lighting device and having a groove part formed at an edge of an opposite side of the lighting device.

### CROSS REFERENCE TO RELATED APPLICATION

This application claims the benefit of Korean Patent Application No. 10-2010-0135563, filed on Dec. 27, 2010, entitled “Laser Navigation Module” which is hereby incorporated by reference in its entirety into this application.

### BACKGROUND OF THE INVENTION

1. Technical Field

The present invention relates to a laser navigation module.

2. Description of the Related Art

Generally, personal digital assistants such as a cellular phone, a smart phone, or the like, include a user interface using a keypad, wherein the keypad includes input buttons for numerals, characters, and directions.

Recently, as wireless Internet services such as wireless broadband (WIBRO) services are commercialized, personal digital assistants have also employed a windows operation system supporting a graphical user interface (GUI).

As described above, the development of input devices that can be conveniently and simply used by a user while being appropriate for mobile communication terminals employing the operation system of the GUI as the user interface of the personal digital assistants has been urgently needed. As a result, a touch key, a joystick, an optical point device, or the like, sequentially performing an input using a keypad that is displayed on a display screen of a mobile communication terminal has been developed. One of them is a laser navigation module including a window and a lid.

The laser navigation module does not include separate lighting devices, such that it is difficult for a user to use the laser navigation module at a dark place.

In more detail, FIG. 1 is an exploded perspective view schematically showing an input device for a mobile communication terminal, a laser navigation module according to the prior art. As shown in FIG. 1, the laser navigation module 100 may be configured to include a window 110, a housing 120, a lid 130, a control IC chip 140, a printed circuit board 150, and a dome switch 160.

The window 110 transmits a laser beam radiated from a light source and shields the introduction of visible rays. In addition, the window is received in the housing 120. The lid 130 is disposed under the window 110 and serves as a shielding part to shield the introduction of spill light. The lid 130 includes a step 131, a circular hole 132, and a rectangular penetration part 133. The step 131 is to more closely couple the housing 120, the circular hole 132 is to transmit a laser beam radiated from the light source, and the rectangular penetration part 133 is to transmit a laser beam that is collected by being reflected and refracted from a user's body contacting the window, or the like.

The control IC chip 140 includes a light source of a laser beam, VSCEL 141 and is to calculate a displacement value between laser beams collected by being reflected and refracted from the window. The control IC chip 140 is coupled with the printed circuit board 150. The dome switch 160 is coupled with the lower portion of the printed circuit board 150. The dome switch 160 senses the pressure of a user to transfer the selection signals of the user to a controller (not shown) disposed thereunder.

The laser navigation module according to the prior art does not include the separate lighting devices as described above, such that it is difficult for the user to use the laser navigation module at a dark place. It may be considered to mount the lighting device at the outside of the laser navigation module, but it is very difficult to mount the lighting device in a very small-sized laser navigation module. Further, the laser navigation module according to the related art cannot uniformly radiate light radiated from the lighting device in the laser navigation module at desired luminance.

### SUMMARY OF THE INVENTION

The present invention has been made in an effort to provide a laser navigation module including a lighting device provided in a housing of the laser navigation module and a light diffusing member transferring light radiated from the lighting device to uniformly transferring light through the light diffusing member in order to uniformly radiate light to the outside of the laser navigation module, thereby making it possible to allow the user to conveniently use the laser navigation module even at a dark place.

According to a preferred embodiment of the present invention, there is provided a laser navigation module, including: a light source radiating a laser beam; a housing provided with a window transmitting and reflecting the laser beam radiated from the light source and shielding the introduction of visible rays and provided with a transparent part or a translucent part to radiate light radiated from the inside thereof to the outside; a lighting device mounted in the housing; and a light diffusing member transferring the light radiated from the lighting device and having a groove part formed at an edge of an opposite side of the lighting device.

The light diffusion member may be provided with a penetration part transmitting the light radiated from the light source and protrusions formed to correspond to the lighting device and switching a direction of the light radiated from the lighting device, and the groove part may be formed at an edge of a side formed with the protrusions.

The light diffusion member may be provided with a penetration part transmitting the light radiated from the light source and protrusions formed to correspond to the lighting device and switching a direction of light radiated from the lighting device and may be divided into two areas of a protrusion forming area and a protrusion non-forming area, wherein the edge of the protrusion forming area being provided with a groove part.

Two lighting devices may be provided and the light diffusing member may be provided with a penetration part transmitting the light radiated from the light source and two protrusions formed to correspond to the lighting device and switching a direction of light radiated from the lighting device and may be divided into two areas of a protrusion forming area and a protrusion non-forming area, wherein the edge of the protrusion forming area being provided with two groove parts.

The laser navigation module may further include: a lid disposed under the window, serving as a shielding part for shielding the introduction of spill light, and including a circular hole and a rectangular penetration part; a control IC chip including the VCSEL and calculating a displacement value between laser beams collected by being reflected and refracted from the window; a printed circuit board coupled with the control IC chip; and a dome switch formed on the lower portion of the printed circuit board.

### BRIEF DESCRIPTION OF THE DRAWINGS

FIG. 1 is an exploded perspective view schematically showing a laser navigation module according to a prior art;

FIG. 2 is a schematic cross-sectional view of a laser navigation module according to a preferred embodiment of the present invention;

FIG. 3 is a perspective view schematically showing a light diffusing member in the laser navigation module according to the preferred embodiment of the present invention;

FIG. 4 is a plan view schematically showing a light diffusing member shown in FIG. 3; and

FIG. 5 is a light radiating measurement schematically showing light radiating distribution of a housing in a laser navigation module according to the preferred embodiment of the present invention.

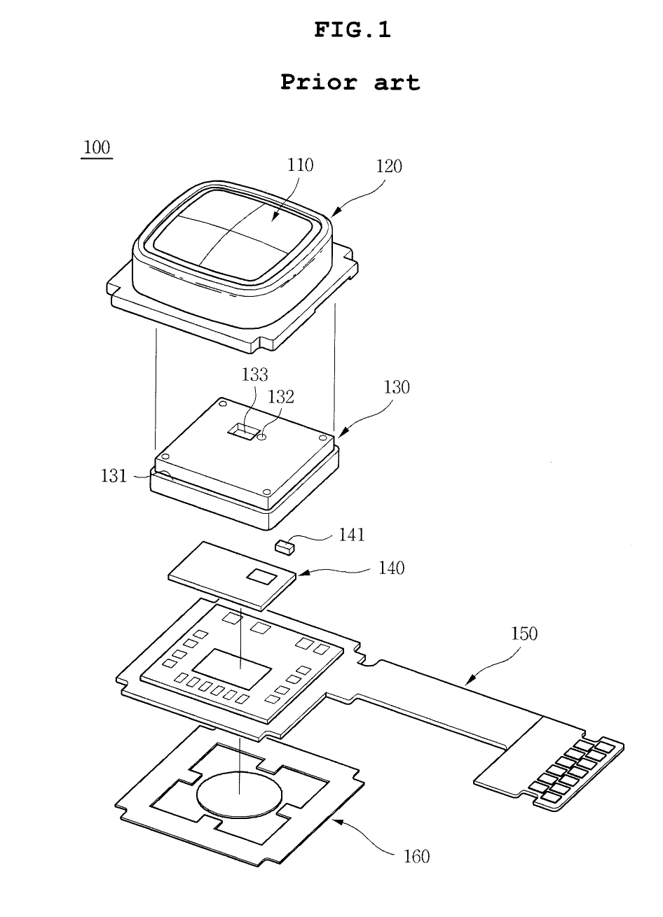

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Terms used in the specification, ‘first’, ‘second’, etc. can be used to describe various components, but the components are not to be construed as being limited to the terms. The terms are only used to differentiate one component from other components. Further, when it is determined that the detailed description of the known art related to the present invention may obscure the gist of the present invention, the detailed description will be omitted.

Hereinafter, the preferred embodiments of the present invention will be described in detail with reference to the accompanying drawings.

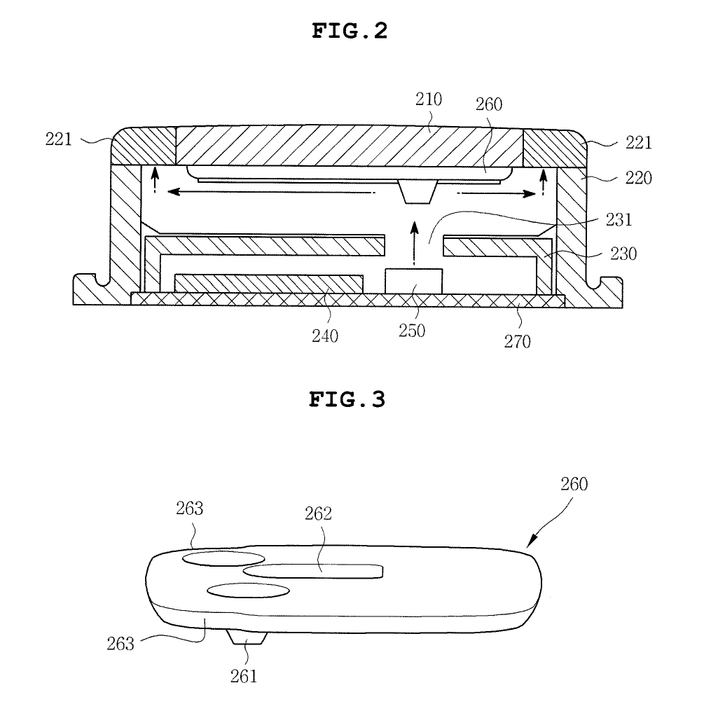

FIG. 2 is a schematic cross-sectional view of a laser navigation module according to a preferred embodiment of the present invention. As shown in FIG. 2, the laser navigation module 200 may be configured to include an IR window 210, a housing 220, VCSEL (not shown), a lid 230, a control IC chip 240, a lighting device 250, a light diffusing member 260, a printed circuit board 270, and a dome switch (not shown).

In the laser navigation module according to the preferred embodiment of the present invention, a printed circuit board 270 is disposed on the upper portion of the dome switch (not shown) and a control IC chip 240, the VCSEL (not shown), and the lighting device 250 are mounted on the upper portion of the printed circuit board 270, according to a stacking sequence. The lid 230 is coupled with the upper portion of the lighting device and the VCSEL. In addition, the light diffusing member 260 is coupled with the upper portion of the lid 230 and the housing 220 mounted with the IR window 210 is coupled with the upper portion of the light diffusing member 260.

In more detail, the lid 230 serves as a light shield part for shielding the introduction of spill light and is provided with a circular hole (not shown) and a rectangular penetration part transmitting a laser beam radiated from a light source, the VCSEL and is provided with a through hole 231 transmitting light radiated from the lighting device 250.

The control IC chip 240 includes a light source, the VCSEL radiating a laser beam and calculates a displacement value between laser beams collected by being reflected and refracted from an IR window. In addition, the IR window 210 transmits and reflects the laser beam radiated from the VCSEL and shields the introduction of visible rays.

Further, the lighting device 250 serves to radiate light to the outside of the housing and may be implemented as an LED.

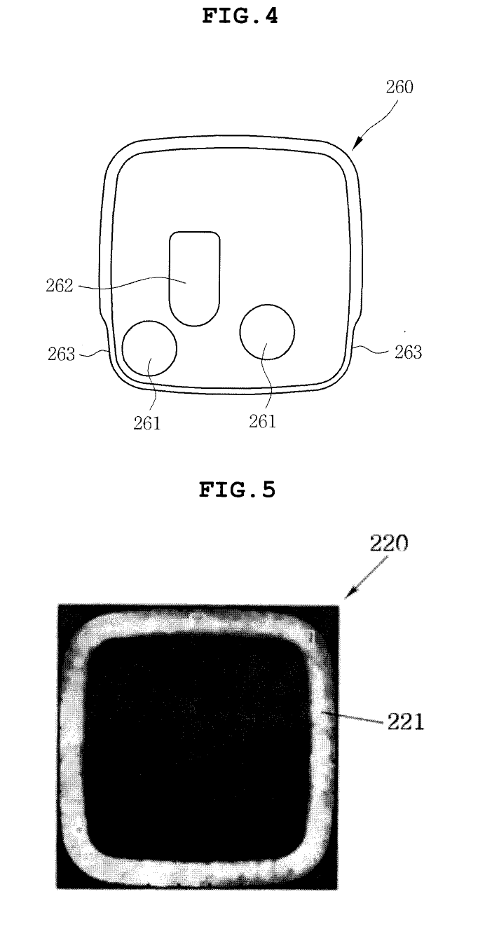

Further, the light diffusing member 260 is provided with protrusions 261 to switch and diffuse propagation of light radiated from the lighting device and is provided with a penetration part (shown by 262 in FIG. 3) transmitting the laser beam radiated from the VCSEL. In addition, since the lighting device may not be disposed at the middle of the housing in consideration of the position of the VCSEL, or the like, the protrusion 261 is biased to one side to switch the propagation direction of radiated light and the formation position thereof may not also be disposed on the middle of the light diffusion member 260. The shape of the light diffusing member 260 will now be described in more detail with reference to FIGS. 3 and 4.

In addition, the lighting device 250 may be disposed in one or plural. As described below, FIG. 4 shows the light diffusion member for the case where two lighting devices are mounted. In addition, the lighting device may be implemented as an LED.

The housing 220 of the laser navigation module according to the preferred embodiment of the present invention is provided with a transparent or a translucent part 221 in order to radiate the light radiated from the lighting device to the outside.

FIG. 3 is a perspective view schematically showing a light diffusing member in the laser navigation module according to the preferred embodiment of the present invention and FIG. 4 is a plan view schematically showing a light diffusing member shown in FIG. 3.

As shown, the light diffusing member 260 is formed to correspond to the lighting unit and is provided with the protrusion 261 to switch a path of light radiated from the lighting unit. In addition, the light diffusion member 260 is provided with the penetration part 262 transmitting the light radiated from the light source, the VCSEL (not shown). Further, the protrusion 261 is formed to correspond to the lighting unit. When the plurality of lighting units are provided, the plurality of corresponding protrusions are provided.

In addition, in the light diffusing member, an edge on an opposite side of the lighting device is provided with a groove part 263. In more detail, the groove part is formed at an edge of a side formed with the protrusions 261, which concentrates a relatively large amount of light on the protrusions 261 and controls the amount of radiated light, thereby averaging the amount of radiated light radiated to the outside of the housing.

To this end, the light diffusion member 260 is divided into two areas, i.e., a protrusion forming area and a protrusion non-forming area and the edge of the protrusion forming area is provided with the groove part 263.

When two LEDs, that are the lighting devices of the laser navigation module according to the preferred embodiment of the present invention, are provided, two protrusions are formed corresponding to the two LEDs and the edge of the two protrusions forming area may be provided with two groove parts 263.

FIG. 5 is a light radiating measurement schematically showing light radiating distribution of a housing in a laser navigation module according to the preferred embodiment of the present invention. As shown in FIG. 5, a dead zone (D) or an unbalance does not occur in the transparent or the translucent part 221 of the housing 220, such that the light from the lighting device is uniformly radiated.

As set forth above, the preferred embodiment of the present invention provides the laser navigation module including a lighting device provided in a housing of the laser navigation module and a light diffusing member transferring light radiated from the lighting device to uniformly transferring light through the light diffusing member in order to uniformly radiate light to the outside of the laser navigation module, thereby making it possible to allow the user to conveniently use the laser navigation module even at a dark place.

Although the embodiments of the present invention has been disclosed for illustrative purposes, it will be appreciated that a laser navigation module according to the invention is not limited thereby, and those skilled in the art will appreciate that various modifications, additions and substitutions are possible, without departing from the scope and spirit of the invention. Accordingly, any and all modifications, variations or equivalent arrangements should be considered to be within the scope of the invention, and the detailed scope of the invention will be disclosed by the accompanying claims.

What is claimed is:

1. A laser navigation module, comprising:
a light source radiating a laser beam;
a housing provided with a window transmitting and reflecting the laser beam radiated from the light source and shielding the introduction of visible rays and provided with a transparent part or a translucent part to radiate light radiated from the inside thereof to the outside;
a lighting device mounted in the housing; and
a light diffusing member transferring the light radiated from the lighting device and having a groove part formed at an edge of an opposite side of the lighting device.

2. The laser navigation module as set forth in claim 1, wherein the light diffusion member is provided with a penetration part transmitting the light radiated from the light source and protrusions formed to correspond to the lighting device and switching a direction of the light radiated from the lighting device, and the groove part is formed at an edge of a side formed with the protrusions.

3. The laser navigation module as set forth in claim 1, wherein the light diffusion member is provided with a penetration part transmitting the light radiated from the light source and protrusions formed to correspond to the lighting device and switching a direction of light radiated from the lighting device and is divided into two areas of a protrusion forming area and a protrusion non-forming area, the edge of the protrusion forming area being provided with a groove part.

4. The laser navigation module as set forth in claim 1, wherein two lighting devices are provided, and
the light diffusing member is provided with a penetration part transmitting the light radiated from the light source and two protrusions formed to correspond to the lighting device and switching a direction of light radiated from the lighting device and is divided into two areas of a protrusion forming area and a protrusion non-forming area, the edge of the protrusion forming area being provided with two groove parts.

5. The laser navigation module as set forth in claim 1, further comprising:
a lid disposed under the window, serving as a shielding part for shielding the introduction of spill light, and including a circular hole and a rectangular penetration part;
a control IC chip including the VCSEL and calculating a displacement value between laser beams collected by being reflected and refracted from the window;
a printed circuit board coupled with the control IC chip; and
a dome switch formed on the lower portion of the printed circuit board.
